(19) United States
(12) Patent Application Publication
(10) Pub. No.: US 2026/0367545 A1
(43) Pub. Date: Nov. 19, 2026

(54) OPTICAL SCANNING DEVICE AND IMAGE FORMING APPARATUS

(71) Applicant: KYOCERA Document Solutions Inc., Osaka (JP)

(72) Inventor: Kei OUCHI, Osaka (JP)

(73) Assignee: KYOCERA Document Solutions Inc., Osaka (JP)

(21) Appl. No.: 19/672,056

(22) Filed: May 8, 2026

(30) Foreign Application Priority Data
May 14, 2025 (JP) 2025-081398

(51) Int. Cl. G03G 15/041; B41J 2/447; B41J 2/47; G03G 15/00; G03G 15/04

(52) U.S. Cl. CPC G03G 15/0415; B41J 2/447; B41J 2/471; G03G 15/04036; G03G 15/80

(57) ABSTRACT

An optical scanning device includes a light emitting element, a scanning optical system, an optical sensor, a control board, and a housing. The housing includes a first housing portion housing the scanning optical system, a second housing portion housing the light emitting element, the optical sensor, and the control board, and an inner wall portion partitioning an interior space of the housing into the first housing portion and the second housing portion. The inner wall portion has formed therein a light-emitting-side opening portion that is located on an optical axis of a light beam emitted from the light emitting element and through which the light beam passes and a light-receiving-side opening portion that is located on an optical axis of the light beam incident on the optical sensor and through which the light beam passes.

### INCORPORATION BY REFERENCE

This application is based on and claims the benefit of priority from Japanese Patent Application No. 2025-081398 filed on May 14, 2025, the contents of which are hereby incorporated by reference.

### BACKGROUND

The present disclosure relates to an optical scanning device and an image forming apparatus.

Conventionally, some electrophotographic image-forming apparatuses are equipped with an optical scanning device. The optical scanning device includes a light emitting element, a scanning optical system, an optical sensor, and a housing. The optical scanning device scans a light beam emitted from the light emitting element across an image carrier via the scanning optical system. Thereby, a desired electrostatic latent image is formed on a surface of the image carrier.

The optical sensor detects the light beam scanned by the scanning optical system. The optical scanning device/scanning optical system is configured to control the timing of scanning the light beam based on a result of detection by the optical sensor.

The housing includes a housing portion, a securing portion, and an inner wall portion. The housing portion, which is a portion in which the scanning optical system is housed, is an internal portion of the housing. The securing portion is a portion located outside the housing portion of the housing. The securing portion is exposed outside the housing. The light emitting element and the optical sensor are secured to the securing portion.

An inner wall portion separates the housing portion and the securing portion from each other and defines the housing portion. In the inner wall portion, a light-emitting-side opening portion and a light-receiving-side opening portion are formed. The light beam emitted from the light emitting element toward the scanning optical system passes through the light-emitting-side opening portion. Further, the light beam incident on the optical sensor from the scanning optical system passes through the light-receiving-side opening portion.

### SUMMARY

According to one aspect of the present disclosure, an optical scanning device includes a light emitting element, a scanning optical system, an optical sensor, a control board, and a housing. The light emitting element emits a light beam. The scanning optical system scans the light beam to direct it onto an image carrier. The optical sensor detects the light beam scanned by the scanning optical system. The control board has the light emitting element and the optical sensor electrically connected thereto. The housing houses the light emitting element, the scanning optical system, the optical sensor, and the control board in an interior space thereof. The housing includes a first housing portion that houses the scanning optical system, a second housing portion that houses the light emitting element, the optical sensor, and the control board, and an inner wall portion that partitions the interior space into the first housing portion and the second housing portion. The inner wall portion has formed therein a light-emitting-side opening portion that is located on an optical axis of the light beam emitted from the light emitting element and through which the light beam passes, and a light-receiving-side opening portion that is located on an optical axis of the light beam incident on the optical sensor and through which the light beam passes.

### BRIEF DESCRIPTION OF THE DRAWINGS

FIG. 1 is a side sectional view showing a schematic configuration of an image forming apparatus of the present disclosure.

FIG. 2 is a perspective view showing an overall external appearance of an optical scanning device.

FIG. 3 is a perspective view showing the optical scanning device with an upper lid removed.

FIG. 4 is a perspective view showing a configuration of a light source unit.

FIG. 5 is a sectional perspective view of a housing, with a second housing portion and its surrounding area illustrated in an enlarged manner.

FIG. 6 is a partial sectional view showing the housing cut along a plane perpendicular to a rotation axis direction, as seen in plan view in the rotation axis direction.

FIG. 7 is a sectional view showing a modified example of the optical scanning device according to the present disclosure.

### DETAILED DESCRIPTION

### 1. Overall Configuration of Image Forming Apparatus

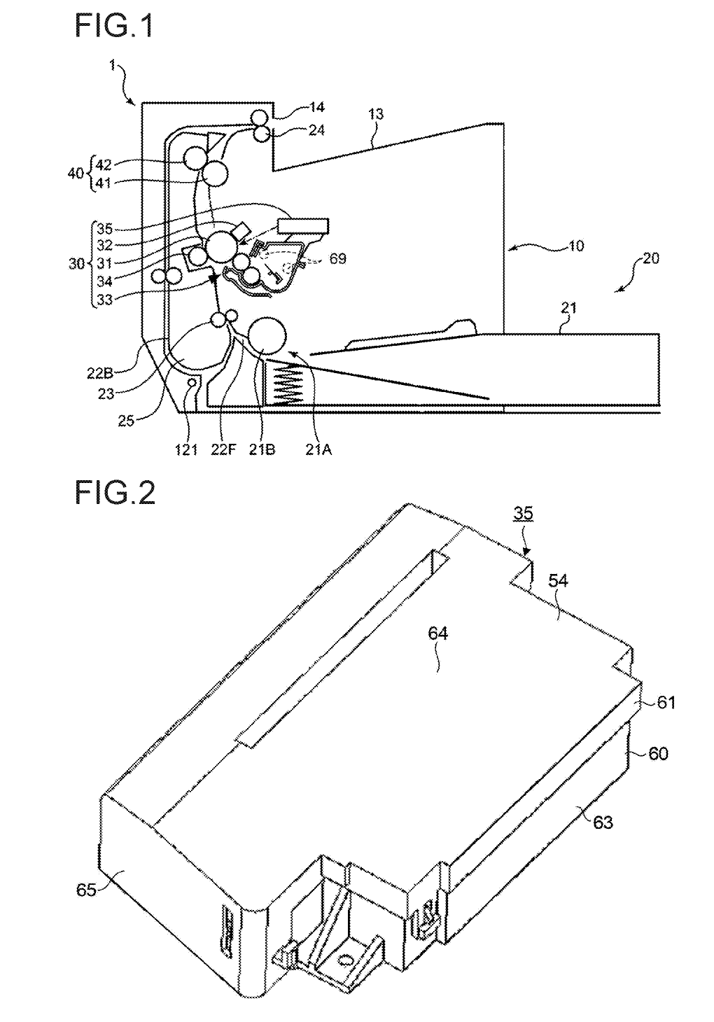

Hereinafter, embodiments of the present disclosure will be described with reference to the accompanying drawings. FIG. 1 is a side sectional view showing a schematic configuration of an image forming apparatus 1 of the present disclosure. The image forming apparatus 1 shown in FIG. 1 is a monochrome printer. As shown in FIG. 1, on an upper surface of a main body of the image forming apparatus 1, a sheet discharge portion 13 is provided to which a sheet (recording medium) having undergone image formation is discharged. Note that, in the following description, the term “sheet” refers to copy paper, coated paper, OHP film, cardboard, postcards, tracing paper, and other sheet materials used for an image forming process.

The image forming apparatus 1 includes a sheet feed portion 20, an image forming portion 30, a developing device 33, and a fixing portion 40.

The sheet feed portion 20 includes a sheet feed cassette 21, a sheet-feed-cassette upper panel 21U, and a sheet feed-out portion 21A. The sheet feed cassette 21 protrudes frontward (rightward in FIG. 1) from a front surface of the image forming apparatus 1. The sheet feed cassette 21 stores a bundle of sheets. The sheet-feed-cassette upper panel 21U covers an upper surface of a part of the sheet feed cassette 21, the part being housed within the main body of the image forming apparatus 1.

The sheet feed-out portion 21A is disposed above a rear end side of the sheet feed cassette 21. The sheet feed-out portion 21A includes a sheet feed roller 21B. The sheet feed-out portion 21A feeds out sheets one by one from a topmost layer of the sheet bundle in the sheet feed cassette 21 as the sheet feed roller 21B rotates.

The image forming portion 30 performs an image forming operation, which is an operation of forming a toner image (a developer image) on a sheet fed out from the sheet feed portion 20. The details of the image forming operation are as follows. The image forming portion 30 includes a photosensitive drum 31, and also includes a charging portion 32, an optical scanning device 35, a developing device 33, and a transfer roller 34, which are disposed around the photosensitive drum 31. The developer used for image formation is a non-magnetic one-component developer consisting only of toner.

The photosensitive drum 31 (an image carrier) includes a rotation shaft and an outer circumferential surface that rotates about the rotation shaft. On an outer peripheral surface of the photosensitive drum 31, a photoconductive layer is formed, which is composed of a known organic photoconductor (OPC), for example, and which includes layers such as a charge generation layer and a charge transport layer. The photosensitive layer is uniformly charged by the charging portion 32, which will be described later, and is then irradiated with light by the optical scanning device 35, as a result of which an electrostatic latent image with attenuated charge is formed thereon. Then, a toner image, formed by developing the electrostatic latent image with the developing device 33, is carried on the photosensitive layer.

The charging portion 32 (a charging device) is disposed with a predetermined space from the outer peripheral surface of the photosensitive drum 31, and charges the outer peripheral surface of the photosensitive drum 31 uniformly in a non-contact state. Specifically, the charging portion 32 includes a charge wire and a grid electrode (of which neither is illustrated).

The charge wire is a line-shaped electrode extending in a rotation axis direction of the photosensitive drum 31. The charge wire generates a corona discharge between itself and the photosensitive drum 31. The grid electrode is a grid-shaped electrode extending in the rotation axis direction of the photosensitive drum 31. The grid electrode is disposed between the charge wire and the photosensitive drum 31. The charging portion 32 causes a current having a predetermined current value to flow through the charge wire to thereby generate a corona discharge, and applies a predetermined voltage to the grid electrode to thereby charge the outer peripheral surface of the photosensitive drum 31, which faces the grid electrode, uniformly to a predetermined surface potential.

The optical scanning device 35 irradiates the outer peripheral surface of the photosensitive drum 31 with light modulated based on image data received from an external device (e.g., a personal computer). Thereby, on the outer peripheral surface of the photosensitive drum 31, an electrostatic latent image is formed corresponding to an image that is based on the image data. A detailed configuration of the optical scanning device 35 will be described later.

The transfer roller 34 includes a rotation shaft extending parallel to a sheet width direction and an outer peripheral surface facing the outer peripheral surface of the photosensitive drum 31. The transfer roller 34 is supported in a main-body housing 10 so as to be rotatable about the rotation shaft. The transfer roller 34 transfers the toner image carried on the outer peripheral surface of the photosensitive drum 31 onto a sheet passing through a nip portion between the transfer roller 34 and the outer peripheral surface of the photosensitive drum 31. During the transfer, a transfer voltage having a polarity reverse to that of the toner is applied to the transfer roller 34.

The fixing portion 40 is located downstream of the transfer roller 34 in a sheet conveyance direction, and performs a fixing process of fixing the toner image, which has been transferred to a sheet, onto the sheet. The fixing portion 40 includes a fixing roller 41 and a pressure roller 42. The fixing roller 41 includes a heat source inside, and heats the toner transferred onto the sheet to a predetermined temperature. The pressure roller 42 is pressed against the fixing roller 41, so that a fixing nip portion is formed between the pressure roller 42 and the fixing roller 41. When the sheet having the toner image transferred thereto passes through the fixing nip portion, the toner image is fixed onto the sheet by heat from the fixing roller 41 and pressure from the pressure roller 42.

Within the main-body housing 10, a main conveyance path 22F and a reverse conveyance path 22B are provided for sheet conveyance. The main conveyance path 22F extends from the sheet feed-out portion 21A of the sheet feed portion 20, via the image forming portion 30 and the fixing portion 40, up to a sheet discharge port 14 disposed facing the sheet discharge portion 13 on the upper surface of the main-body housing 10. The reverse conveyance path 22B is a conveyance path for, in a case of performing double-sided printing on a sheet, returning the sheet to an upstream side of the image forming portion 30 in the main conveyance path 22F after printing has been performed on one side of the sheet.

The main conveyance path 22F is formed to extend so as to pass, upward from below, through a transfer nip portion formed by the photosensitive drum 31 and the transfer roller 34. Further, upstream of the transfer nip portion in the main conveyance path 22F, a pair of registration rollers 23 are disposed. A sheet is temporarily stopped by the pair of registration rollers 23 for skew correction, and then fed out to the transfer nip portion at predetermined timing for image transfer. A plurality of conveyance rollers for conveying a sheet are disposed at appropriate positions along the main conveyance path 22F and the reverse conveyance path 22B. Near the sheet discharge port 14, a pair of sheet discharge rollers 24 are disposed.

The reverse conveyance path 22B is formed between an outer side surface of a reverse unit 25 and an inner surface of a rear cover 12 of the main-body housing 10. Note that, on an inner side surface of the reverse unit 25, the transfer roller 34 and one roller of the pair of registration rollers 23 are placed. The rear cover 12 and the reverse unit 25 are respectively rotatable about an axis of a fulcrum portion 121 provided at their lower ends. If a jam (a paper jam) occurs in the reverse conveyance path 22B, the rear cover 12 is opened. If a jam occurs in the main conveyance path 22F, or to remove a unit of the photosensitive drum 31 or the developing device 33, the reverse unit 25 is opened as well as the rear cover 12.

### 2. Detailed Configuration of Optical Scanning Device 35

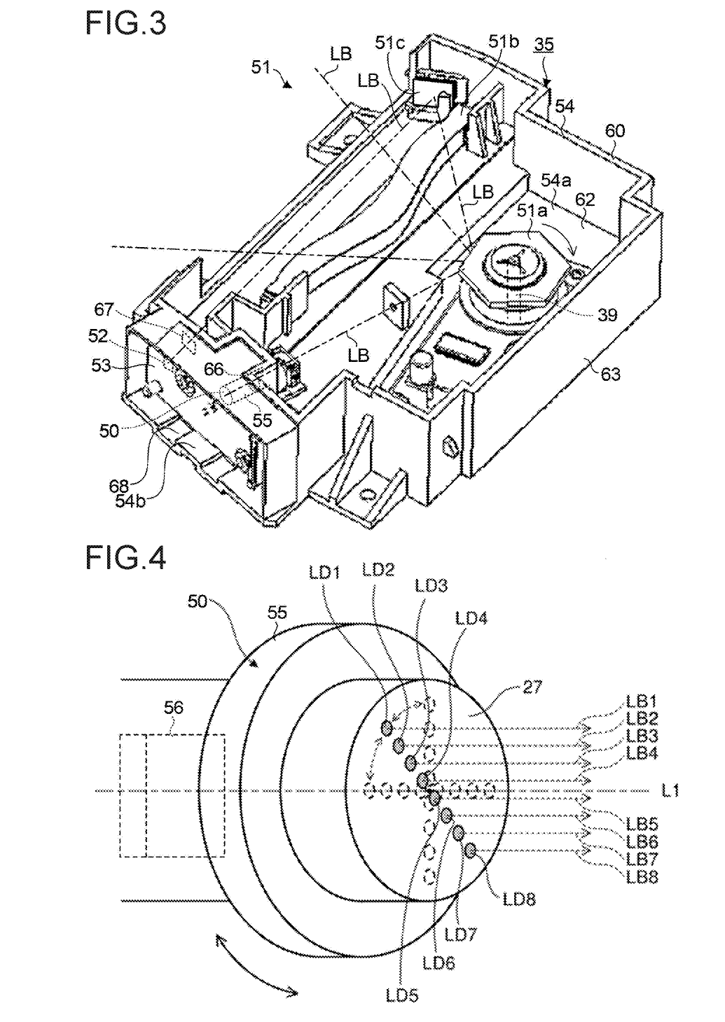

FIG. 2 is a perspective view showing an overall external appearance of the optical scanning device 35. FIG. 3 is a perspective view showing the optical scanning device 35 with an upper lid 61 removed. As shown in FIGS. 2 and 3, the optical scanning device 35 includes a light source unit 50, a scanning optical system 51, an optical sensor 52, a control board 53, and a housing 54. The housing 54 houses, in its interior, the light source unit 50, the scanning optical system 51, the optical sensor 52, and the control board 53. A specific configuration of the housing 54 will be described later.

The light source unit 50 is configured to emit a light beam LB toward the scanning optical system 51 (more specifically, a deflection surface of a polygon mirror 51a, which will be described later). A specific configuration of the light source unit 50 is as follows.

FIG. 4 is a perspective view showing a configuration of the light source unit 50. Note that, in FIG. 4, a holder portion 55 is illustrated in a schematic manner by omitting an outer peripheral part of the holder portion 55. As shown in FIG. 4, the light source unit 50 includes light emitting elements LD1 to LD8, the holder portion 55, and a beam generation portion 56.

The light emitting elements LD1 to LD8 are each a laser diode. The light emitting elements LD1 to LD8 respectively emit laser rays LB1 to LB8. That is, the light beam LB is a bundle of the laser rays LB1 to LB8.

The holder portion 55 is rotatably supported by the housing (more specifically, an inner wall portion 63). The holder portion 55 has a cylindrical external shape. The holder portion 55 is inserted into a light-emitting-side opening portion 66, which will be described later (see FIG. 6, which will be referred to later). A specific configuration of the holder portion 55 is as follows.

The holder portion 55 incorporates the light emitting elements LD1 to LD8. The holder portion 55 has a leading end surface 27 which is a circular flat surface. In the leading end surface 27, openings in a number corresponding to the light emitting elements LD1 to LD8 (here, eight) are formed at positions corresponding to the light emitting elements LD1 to LD8. The light emitting elements LD1 to LD8 are each exposed from a corresponding one of the openings, and respectively emit the laser rays LB1 to LB8 through the openings.

The light emitting elements LD1 to LD8 are arranged in a straight line along a diameter direction of the leading end surface 27. Accordingly, the light beam LB is a band-shaped bundle of light formed by the laser rays LB1 to LB8 arranged in the diameter direction of the leading end surface 27.

The holder portion 55 is supported so as to be rotatable in a circumferential direction about an axis L1, the axis L1 being a normal with respect to the leading end surface 27 and passing through a center of the leading end surface 27. When the holder portion 55 rotates, an interval between the light emitting elements LD1 to LD8 in a sub-scanning direction is caused to vary by the rotation.

When the light emitting elements LD1 to LD8 are arranged in a straight line that is parallel to the sub-scanning direction (an up-down direction in the figure), the interval between the light emitting elements LD1 to LD8 is minimum. On the other hand, when the light emitting elements LD1 to LD8 are arranged in a straight line that is parallel to a main scanning direction, the interval between the light emitting elements LD1 to LD8 is maximum (for both cases, see the broken-line parts shown in FIG. 4).

The beam generation portion 56 is a module installed in a circuit on the control board 53. The beam generation portion 56 is electrically connected to the light emitting elements LD1 to LD8. Based on image information transmitted from a main body of the image forming apparatus 1 (more specifically, a control portion of the image forming apparatus 1), the beam generation portion 56 performs driving control of the light emitting elements LD1 to LD8 (= control of light emission of the laser rays LB1 to LB8).

Referring back to FIG. 3, the scanning optical system 51 will be described. As shown in FIG. 3, the scanning optical system 51 is configured to deflect the light beam LB and direct it toward the peripheral surface of the photosensitive drum 31. A specific configuration of the scanning optical system 51 is as follows. The scanning optical system 51 includes a polygon mirror 51a, a scanning lens 51b, and a sensor mirror 51c.

The polygon mirror 51a is a regular polygonal prism member (here, a hexagonal prism member) having deflection surfaces formed on all of its side surfaces. The deflection surfaces are mirror surfaces capable of reflecting the light beam LB shone on them. The polygon mirror 51a is rotatably supported by a rotation shaft 39 that is located at its center. The rotation shaft 39 is a straight round bar (shaft body). The rotation shaft 39 is configured to rotate by receiving a rotation driving force from an unillustrated polygon motor. Note that, in the following description, an axial direction of the rotation shaft 39 will be simply referred to as “the rotation axis direction”.

The polygon motor is a motor that outputs the rotation driving force. The polygon motor is secured to the housing 54 (more specifically, a first housing portion 54a, which will be described later).

The polygon mirror 51a rotates in a circumferential direction about the rotation shaft 39 by receiving the rotation driving force from the polygon motor via the rotation shaft 39. When the polygon mirror 51a rotates, the light beam LB shone on the deflection surfaces is deflected in the main scanning direction.

The scanning lens 51b is a lens having an f-θ characteristic. The scanning lens 51b images the light beam LB that has passed therethrough on a desired position (here, on the peripheral surface of the photosensitive drum 31).

The sensor mirror 51c is a folding mirror that folds back and reflects the light beam LB incident thereon. The sensor mirror 51c is disposed at a position that is outside an irradiation region, through which the light beam LB having passed through the scanning lens 51b is shone onto the photosensitive drum 31, and that is also on a downstream side in the main scanning direction of the light beam LB (on a downstream side in a rotation direction of the polygon mirror 51a). The sensor mirror 51c reflects the light beam LB incident thereon toward the optical sensor 52.

The optical sensor 52 is a sensor of an optical type that detects the light beam LB incident thereon. As the optical sensor 52, various kinds of light sensors, such as a photodiode, a phototransistor, a photo IC, and the like may be used. The optical sensor 52 is mounted on the single control board 53 together with the light emitting elements LD1 to LD8. That is, the optical sensor 52 and the light emitting elements LD1 to LD8 are electrically and mechanically connected onto the control board 53.

The control board 53 includes an IC driver. The IC driver is connected to a signal circuit within the optical sensor 52, the beam generation portion 56, and the light emitting elements LD1 to LD8, in an electrically communicable manner. The IC driver varies a write clock based on a detection result of the light beam LB, and adjusts scanning start timing of the light beam LB in the main scanning direction (e.g., light-emitting timing of the light emitting elements LD1 to LD8).

On the control board 53, a connector portion 70 is mounted. The connector portion 70 is a receptacle-side terminal for cable connection. The connector portion 70 functions as input and output terminals of a circuit (one configured by including the IC driver, the optical sensor 52, the beam generation portion 56, and the light emitting elements LD1 to LD8, which are described above) on the control board 53.

The connector portion 70 is mounted on a surface (the surface being oriented toward an outside of the housing 54) of the control board 53 that is opposite to the surface (the surface being oriented toward an inside of the housing 54) on which the optical sensor 52 and the light source unit 50 (more specifically, the light emitting elements LD1 to LD8) are mounted.

The light beam LB emitted from the light source unit 50 is shone onto the deflection surfaces of the polygon mirror 51a. As described previously, the light beam LB shone onto the deflection surfaces is deflected and scanned by the rotation of the polygon mirror 51a. The light beam LB deflected and scanned passes through the scanning lens 51b and is imaged on the peripheral surface of the photosensitive drum 31. When the light beam LB is further deflected and scanned, it is directed outside the irradiation region through which the light beam LB is shone onto the photosensitive drum 31. Then, when the light beam LB becomes incident on the sensor mirror 51c, it is reflected by the sensor mirror 51c to be incident on the optical sensor 52. Then, the optical sensor 52 detects the light beam LB.

As shown in FIGS. 2 and 3, the housing 54 includes a main body portion 60 and the upper lid 61. The main body portion 60 includes a bottom surface portion 62, an inner wall portion 63, and a protrusion portion 68. The bottom surface portion 62 extends along a direction perpendicular to the rotation shaft 39. On the bottom surface portion 62, the scanning optical system 51 (more specifically, the polygon mirror 51a, the scanning lens 51b, and the sensor mirror 51c) is secured.

The inner wall portion 63 extends from a peripheral edge of the bottom surface portion 62 along the rotation axis direction toward the upper lid 61. That is, the inner wall portion 63 is disposed along the peripheral edge of the bottom surface portion 62 so as to surround the scanning optical system 51.

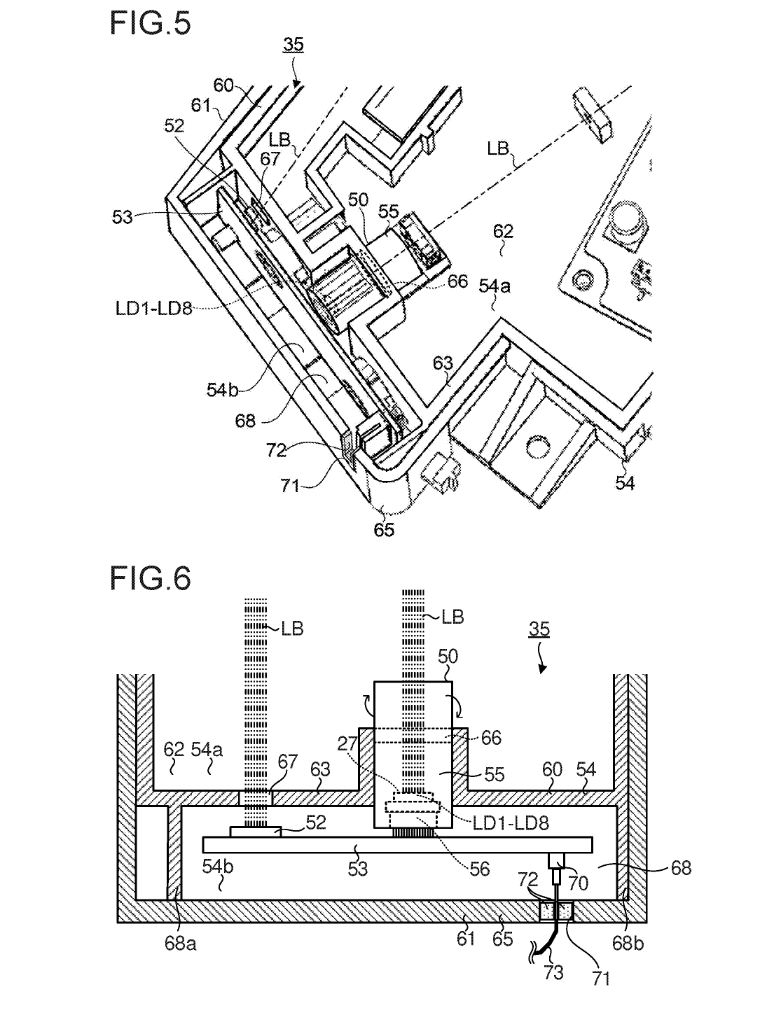

FIG. 5 is a sectional perspective view of the housing 54, with a second housing portion 54b and its surrounding area illustrated in an enlarged manner. FIG. 6 is a partial sectional view showing the housing 54 cut along a plane perpendicular to the rotation axis direction, as seen in plan view in the rotation axis direction. Note that FIG. 6 is a schematic diagram schematically showing various portions of the housing 54.

As shown in FIGS. 5 and 6, the inner wall portion 63 has the light-emitting-side opening portion 66 and a light-receiving-side opening portion 67 formed therein. The light-emitting-side opening portion 66 and the light-receiving-side opening portion 67 are through holes that penetrate the inner wall portion 63. When the inner wall portion 63 is viewed in plan along an optical axis direction of the light beam LB from a polygon-mirror-51a side, the light-emitting-side opening portion 66 is disposed at a position overlapping the light emitting elements LD1 to LD8. In other words, the light beam LB, inside the holder portion 55, passes through the light-emitting-side opening portion 66, and is shone onto the polygon mirror 51a.

The light-emitting-side opening portion 66 is an opening having a circular shape in plan view. As described previously, through the light-emitting-side opening portion 66, the holder portion 55 is inserted. Further, the holder portion 55 has a cylindrical exterior shape. As a result, the holder portion 55 is rotatably supported by the light-emitting-side opening portion 66 such that an outer circumferential surface of the holder portion 55 slides along an inner circumferential surface of the light-emitting-side opening portion 66. The holder portion 55 and the light-emitting-side opening portion 66 are in a clearance fit. That is, between the holder portion 55 and the light-emitting-side opening portion 66, a slight clearance is provided to allow the sliding described above.

The light-receiving-side opening portion 67 is disposed at a position overlapping the optical sensor 52 when the inner wall portion 63 is viewed in plan in an optical axis direction of the light beam LB from a sensor-mirror-51c side. In other words, the light beam LB reflected from the sensor mirror 51c passes through the light-receiving-side opening portion 67 to be incident on the optical sensor 52.

The protrusion portion 68 extends from the peripheral edge of the bottom surface portion 62 in a direction parallel to the bottom surface portion 62 (a direction perpendicular to the rotation axis direction). In other words, the protrusion portion 68 protrudes, from part of a connection portion between the inner wall portion 63 and the bottom surface portion 62, in a direction parallel to the bottom surface portion 62. The protrusion portion 68 faces an upper surface portion 64 in the rotation axis direction.

On an inner surface of the protrusion portion 68 (an upper-lid-61-side surface thereof), partition portions 68aand 68b are formed. The partition portions 68a and 68bface each other with the control board 53 interposed therebetween. The partition portions 68aand 68b extend from the protrusion portion 68 toward the upper lid 61 along the rotation axis direction. The partition portions 68aand 68bare connected to the inner wall portion 63. In other words, the partition portions 68aand 68bextend from an outside surface of the inner wall portion 63, along a peripheral edge of the protrusion portion 68, in a direction perpendicular to the inner wall portion 63.

The upper lid 61 includes the upper surface portion 64 and a peripheral wall portion 65. The upper surface portion 64 extends along a direction perpendicular to the rotation axis direction. The upper surface portion 64 faces the bottom surface portion 62 along the rotation axis direction. The peripheral wall portion 65 extends from a peripheral edge of the upper surface portion 64, along the rotation axis direction, toward the bottom surface portion 62.

The upper lid 61 is attached so as to fit onto an outer side of the main body portion 60, and is secured integrally with the main body portion 60. That is, the peripheral wall portion 65 is located outside the inner wall portion 63. An inside of a space surrounded by the inner wall portion 63 and the peripheral wall portion 65 is defined as an interior space of the housing 54.

In a state in which the upper lid 61 is attached to the main body portion 60, a leading edge of the inner wall portion 63 is in contact with the upper surface portion 64. As a result, the inner wall portion 63 divides the interior space of the housing 54 into the first housing portion 54a and a second housing portion 54b. The first housing portion 54a is located inside the inner wall portion 63. In other words, the first housing portion 54a is enclosed and defined by the bottom surface portion 62, the inner wall portion 63, and the upper surface portion 64. The first housing portion 54a houses the scanning optical system 51.

The second housing portion 54b is located outside the inner wall portion 63 but inside the peripheral wall portion 65. In other words, the second housing portion 54b is enclosed and defined by the bottom surface portion 62, the inner wall portion 63, the upper surface portion 64, and the peripheral wall portion 65. In the second housing portion 54b, the light source unit 50 (more specifically, the light emitting elements LD1 to LD8), the optical sensor 52, and the control board 53 are housed. The control board 53 is screw-fastened to a boss (not illustrated) disposed on the peripheral wall portion 65 and is thereby secured to the upper lid 61.

The peripheral wall portion 65 has an exit hole 71 formed therein. The exit hole 71 is a rectangular-shaped through hole. The exit hole 71 is shaped to fit a shape of a cable 73, which will be described later. When the peripheral wall portion 65 is viewed in plan in a direction perpendicular to a mounting surface of the control board 53, the exit hole 71 is disposed at a position overlapping the connector portion 70. The exit hole 71 is opened wider than a connecting part of the connector portion 70 so that, in the above-mentioned plan view, the exit hole 71 is located outward of an outer periphery of the connector portion 70.

Along an inner peripheral edge of the exit hole 71, an elastic member 72 is disposed.

The elastic member 72 is an elastic body having a predetermined degree of cushioning (elasticity).

The elastic member 72 has a through hole formed at a center thereof so that the exit hole 71 is not closed. For example, the elastic member 72 can be a sponge, grommet, etc. The elastic member 72 is secured in the exit hole 71 by press-fitting, bonding, or the like so as to cover an entire inner peripheral surface of the exit hole 71.

Assume that, as shown in FIG. 6, a predetermined cable 73 is connected to the connector portion 70. The cable 73 is a cable for electrically connecting the circuit on the control board 53 to a circuit outside the optical scanning device 35 to transmit predetermined input/output signals. At this time, the cable 73 extends from outside the housing 54, passes through the exit hole 71, and is connected to the connector portion 70.

In a state in which the cable 73 is not inserted in the connector portion 70, the second housing portion 54b communicates with space outside the housing 54 communicate via the exit hole 71 (and the elastic member 72). In a state in which the cable 73 is inserted in the connector portion 70, a leading edge of the elastic member 72 is in elastic contact with a surface of the cable 73. At this time, the elastic member 72 closes a space between the cable 73 and the exit hole 71. That is, at this time, the exit hole 71 is closed by the elastic member 72 and the cable 73, so that the communication between the second housing portion 54b and the space outside the housing 54 is eliminated, resulting in a closed state.

### 3．Considerations

Among conventional optical scanning devices, some include a control board (corresponding to the control board 53 described above) secured externally to a housing (corresponding to the housing 54 described above). In a case where an optical sensor (corresponding to the optical sensor 52 described above) and a light source unit (corresponding to the light source unit 50 described above) are mounted on such a control board, an opening (corresponding to the light-emitting-side opening portion and the light-receiving-side opening portion described above) is formed in an outer peripheral part of a housing to allow a light beam to pass therethrough. Then, there is a risk that dust from outside the housing will enter the interior space of the housing. Such entry of dust into the housing may result in reduced image-forming accuracy and degraded image quality.

In particular, in a configuration in which the light source unit is rotated to adjust the spacing of the laser rays in the main scanning direction and the sub-scanning direction, a relatively large clearance is provided between the light source unit and the opening in which the light source unit is inserted. As a result, dust is more likely to enter the interior of the housing through this clearance.

On the other hand, in the optical scanning device 35 of the present disclosure, entry of dust is suppressed, thereby suppressing reduction in image-forming accuracy and degradation of image quality. Specifically, as described above, the second housing portion 54b is enclosed by the inner wall portion 63, the protrusion portion 68, and the upper surface portion 64. As a result, dust is less likely to enter the housing. That is, dust existing outside the housing 54 is less likely to reach the light-emitting-side opening portion 66 and the light-receiving-side opening portion 67. Thus, it is possible to suppress entry of dust, through the light-emitting-side opening portion 66 and the light-receiving-side opening portion 67, into the first housing portion 54a. And, the scanning optical system 51 is disposed in the first housing portion 54a. Accordingly, the image forming apparatus 1 incorporating the optical scanning device 35 is capable of suppressing reduction in image-forming accuracy and degradation of image quality.

Further, as described above, when the cable 73 is inserted through the exit hole 71, an opening area of the exit hole 71 is reduced by the cable 73. As a result, entry of dust into the second housing portion 54b can be suppressed more effectively.

Further, as described above, when the cable 73 is connected to the connector portion 70, the elastic member 72 is in elastic contact with an outer circumferential surface of the cable 73. Thereby, the space between the exit hole 71 and the cable 73 is properly closed by the elastic member 72. Thus, entry of dust into the second housing portion 54b is suppressed more effectively.

Further, as described above, the leading edge of the inner wall portion 63 is in contact with the upper surface portion 64. Furthermore, leading edges of the partition portions 68a and 68b (edge parts thereof on the upper-surface-portion-64 side in the rotation axis direction) are in contact with the upper surface portion 64. Thereby, the second housing portion 54b is defined by the protrusion portion 68, the partition portion 68a, the partition portion 68b, and the upper surface portion 64 such that no gaps remain between them. This helps effectively suppress entry of dust from outside the housing 54 into the second housing portion 54b.

### 4. Modified Example

It should be understood that the present disclosure is not limited to the foregoing embodiments, and various modifications may be made without departing from the scope and spirit of the disclosure. For example, the elastic member 72 is not essential and may be omitted. In this case, as well, the gap between the surface of the cable 73 and the inner peripheral surface of the exit hole 71 is relatively narrow. In this case, as well, the exit hole 71 is also closed by the cable 73.

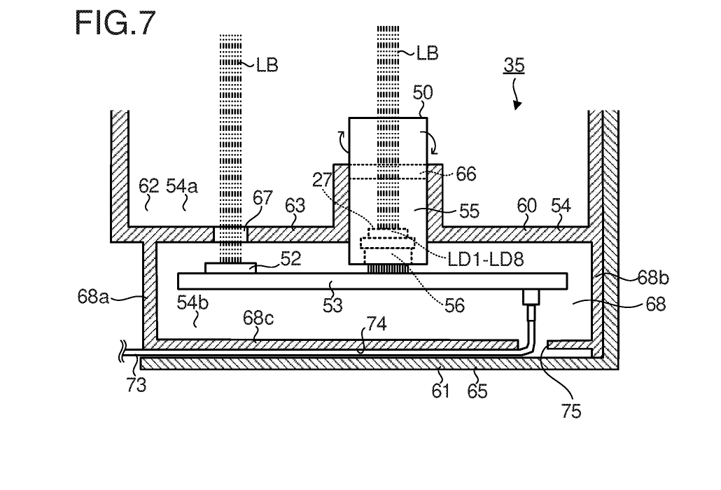

Furthermore, in this case, a configuration shown in FIG. 7 can be employed, for example. In this configuration, on the peripheral edge of the protrusion portion 68, a partition portion 68c is provided. The partition portion 68c is connected to the partition portion 68a. The partition portion 68c extends from the peripheral edge of the protrusion portion 68, along the rotation axis direction, toward the upper surface portion 64. A leading edge of the partition portion 68c in the rotation axis direction is in contact with the upper surface portion 64. The second housing portion 54b is defined by the protrusion portion 68, the partition portion 68a to 68c, and the upper surface portion 64.

The partition portion 68c is located inside the peripheral wall portion 65. The partition portion 68cfaces the peripheral wall portion 65. Between the partition portion 68cand the peripheral wall portion 65, an exit space 74 is formed. The exit space 74 has a width (an opposite distance between the partition portion 68cand the peripheral wall portion 65) that is slightly larger than a thickness of the cable 73.

In the partition portion 68c, an exit hole 75 is formed. When the partition portion 68cis viewed in plan in an insertion direction in which the cable 73 is inserted into the connector portion 70, the exit hole 75 is disposed at a position overlapping the connector portion 70. The exit hole 75 is a rectangular-shaped through hole. In plan view, the exit hole 75 is located outside the connector portion 70 and has a larger opening area than the connector portion 70.

As shown in FIG. 7, in this configuration, when the cable 73 is connected to the connector portion 70, the cable 73 passes through the exit hole 75. The cable 73 extends through the exit space 74 in a manner sandwiched between the partition portion 68c and the peripheral wall portion 65 to be led out from the housing 54.

When this configuration is employed, outside the second housing portion 54b, which is defined by the protrusion portion 68, the partition portions 68a to 68c, and the upper surface portion 64, the peripheral wall portion 65 is additionally disposed. Furthermore, within the exit space 74, which allows communication between the second housing portion 54b and external space, the cable 73 is sandwiched. This makes it difficult for dust to enter the second housing portion 54b. Further, it is possible, without arranging a separate member such as the elastic member 72, to provide an opening (space) for routing the cable 73 out of the second housing portion 54b while suppressing the entry of dust through the opening.

Further, although the image forming apparatus 1 is assumed to be a monochrome printer in the above description, it may instead be a full-color printer. In that case, the image forming apparatus 1 includes four photosensitive drums 31 corresponding to four different colors (magenta, cyan, yellow, and black). In that case, the image forming apparatus 1 may employ a configuration that includes four optical scanning devices 35 corresponding to the respective photosensitive drums 31. Further, a configuration may be employed that includes an optical scanning device configured to be able to expose the four photosensitive drums 31 using a single polygon mirror. Such an optical scanning device also has a configuration similar to that of the optical scanning device 35. Accordingly, it is possible to provide an image forming apparatus 1 capable of suppressing entry of dust and thus to suppress reduction in image-forming accuracy and degradation of image quality.

The present disclosure is applicable to an optical scanning device that scans a light

beam emitted from a light source across a surface (scanned surface) of a photosensitive drum to form an electrostatic latent image. By employing the present disclosure, it is possible to provide an optical scanning device capable of suppressing an increase in the overall device size.

1. An optical scanning device, comprising:
a light emitting element that emits a light beam;
a scanning optical system that scans the light beam and directs the light beam onto an image carrier;
an optical sensor that detects the light beam scanned by the scanning optical system;
a control board to which the light emitting element and the optical sensor are electrically connected; and
a housing that houses, in an interior space thereof, the light emitting element, the scanning optical system, the optical sensor, and the control board,
wherein
the housing includes:
a first housing portion that houses the scanning optical system;
a second housing portion that houses the light emitting element, the optical sensor, and the control board; and
an inner wall portion that partitions the interior space into the first housing portion and the second housing portion, and
the inner wall portion has formed therein:
a light-emitting-side opening portion that is located on an optical axis of the light beam emitted from the light emitting element and through which the light beam passes; and
a light-receiving-side opening portion that is disposed on an optical axis of the light beam incident on the optical sensor and through which the light beam passes.

2. The optical scanning device according to claim 1,
wherein
the housing includes:
a main body portion including the inner wall portion and a bottom surface portion, the scanning optical system being secured to the bottom surface portion; and
an upper lid including an upper surface portion that faces the bottom surface portion and a peripheral wall portion that extends downward from a peripheral edge of the upper surface portion, and
when the upper lid is attached to the main body portion, a leading edge of the inner wall portion comes into contact with the upper surface portion, thereby forming the second housing portion.

3. The optical scanning device according to claim 2,
wherein
the control board includes a connector portion configured to serve as a terminal for inputting and outputting a signal to and from a circuit on the control board,
the peripheral wall portion has formed therein an exit hole that allows communication between the second housing portion and space outside the housing, and
in a connected state in which a cable for inputting and outputting the signal to and from the circuit is connected to the connector portion, the cable is inserted into the exit hole.

4. The optical scanning device according to claim 3, further comprising an elastic member that is disposed along an inner periphery of the exit hole and that is in elastic contact with the cable in the connected state.

5. The optical scanning device according to claim 4, wherein the elastic member is a sponge.

6. The optical scanning device according to claim 1, further comprising a light source unit configured by including a plurality of the light emitting elements and a holder portion that is inserted in the light-emitting-side opening portion so as to be rotatable and that holds the light emitting elements,
wherein
the light source unit is configured such that a pitch of the light beams respectively emitted from the light emitting elements varies in accordance with a rotation angle of the holder portion.

7. An image forming apparatus, comprising:
an image carrier;
a charging device that charges the image carrier;
the optical scanning device according to claim 1 that images the light beam onto the image carrier to form an electrostatic latent image with attenuated charge; and
an image forming portion that develops the electrostatic latent image into a visible image
and that transfers the visible image onto a sheet to form on the sheet an image corresponding to the electrostatic latent image.
